(19) United States
(12) Patent Application Publication
(10) Pub. No.: US 2016/0247114 A1
(43) Pub. Date: Aug. 25, 2016

(54) Digital Business Checkbook

(71) Applicant: Khalid Amri, Saunderstown, RI (US)

(72) Inventor: Khalid Amri, Saunderstown, RI (US)

(73) Assignee: Khalid Amri, Saunderstown, RI (US)

(21) Appl. No.: 14/742,303

(22) Filed: Jun. 17, 2015

Related U.S. Application Data
(60) Provisional application No. 62/119,000, filed on Feb. 20, 2015.

(51) Int. Cl. G06Q 10/06; G06F 11/14; G06Q 20/04; G06Q 10/08; G06Q 10/10; G06Q 40/00

(52) U.S. Cl. CPC G06Q 10/063118; G06Q 10/103; G06Q 40/128; G06Q 40/125; G06Q 20/042; G06Q 10/087; G06F 11/1448

(57) ABSTRACT

A Device and Software/Application that you can install on your Computer and/or Mobile Devices designed by business owners for business owners. You may use it to write & print checks remotely for vendors, service providers, clients and employees paychecks. With a built-in time-clock tracking payroll is made easier than ever before. It can also create expense reports and graphs in seconds to help you see where your money is going.

### FIELD OF THE INVENTION

This invention is an application used to help organize business expenses. It also provides extra security and allows a business owner or authorized users to process payments without having to be near the device.

Being the owner of a business can be a taxing experience. You as the owner have to keep track of bill payments, the hours of your employees, pay sales and withholding taxes, pay for maintenance and repairs plus pay for any other services you require. In order to make these payments you usually need to be able to write the check. And with the current checkbook that is normally used by businesses, you or a highly trusted individual must be on location at the time of delivery, because supply/product deliveries or repairs are usually COD (Cash on Delivery). Then you need to keep track of all your payments, balances and the remaining number of blank checks you have left in your book.

If you are a partner in a business endeavor, and your partners, your accountants or business advisors want to know what the expenses are and you have to provide them with the details, you would have to relay the information via phone, fax or Email which takes time out of your busy day. All of these tasks take time out of your day keeping you from getting more important things done and keeping you from focusing on other aspects of your business.

In summary the point of our invention is to simplify these tasks making them faster, more efficient, more secured'and better organized. Something that more people can do in less time onsite or remotely, something that allows you to take all your data with you anywhere you go, making record keeping easier than ever before and since it's all digital any report is one click away. A company may have different bank accounts for different departments that means more paper checks. With our Digital Checkbook you can use the same blank check stock for unlimited bank accounts. If desired, you can create multiple bank accounts and designate each one to a targeted recipient. When checks are printed to different payees it will automatically print the assigned bank account number on the checks. Unlike the regular check book users, Digital checkbook users won't have to worry about losing or leaving their checks somewhere, because it's secured and password protected only authorized users can use it. And you will still be notified of any activities if you choose to.

### SUMMARY OF INVENTION

Our proposed invention has multiple different features, one of which is our secure servers that automatically backs up user data if they choose to. It not only helps backing up user's data, it also makes it accessible to users from anywhere with any approved device. Security measures may include but are not limited to pin numbers, biometric scans, voice recognition software and passwords. A user may choose from one or more of these security options and set multiple user accounts with varying limit allowed access. In the event the device is lost or stolen, and unauthorized user fails three times to provide proper access information, the device will be locked and encrypted. Only the actual user can recover system and make it reusable. If the device is not recovered, user can simply buy another one and as soon as they log in all their data will be synchronized with the server so nothing is lost.

Another function of our invention is the remote printing capabilities. This feature allows the user to remotely print checks at their business location by using the application on their smart phones or other mobile devices to enter the necessary data and sending the print order, this will be followed by a confirm order on the device (device comes with an attached printer that holds checks and its locked for safety or user can use their existing printers and simply feed it with blank check papers) at the location that contains check stock. Any one onsite can then presses confirm and the check will be printed and given to the target recipient. This allows the user to make necessary payments even when they are away on business trip or at home with their family. User can also create multiple secondary users with different access levels where they can only print checks for approved venders or up to a certain amount limit, or user can elect to let certain people generate a check but only print after main user receives a print request authorization on their smart phones and okays the check release. Each user is assigned a user name and password and they will be required to identify themselves before using the device. You can also create read-only user accounts for your tax filers or accountants to let them see your reports while they do your taxes. You don't have to spend time printing reports and faxing them.

Digital Business Checkbook will also include features that allow the users to search and find checks by recipient, check number amount, department and by date in seconds. This may also include a saved but not duplicable copy of a check showing all of the information. This feature allows the user to provide proof that the check was at least prepared and sent out. These records can also be processed by the application to provide accurate expense reports and graphs to compare expenses by department or to export them to other most common software to further analyze them. This can help users monitor their outgoing funds and expenses more efficiently. These reports can be created in seconds and they are 100% accurate when you reconcile when bank statements it will match penny by penny.

Digital Business Checkbook Calendar invention enables users to program this application to remind them of regular monthly payments or any repeat payments. Users can program the application with just a few inputs to remind them of upcoming payments and due dates. You can choose how many days in advance to be reminded of your payments and you will be prompted with a notification where you can postpone it for a future date or simply click “Print” to automatically propagate all the check fields such as: payee name, amount, date, memo without any errors and print the checks and all you have to do is put it in the mail. No forgetting, no late fees or penalties. The program is designed to replace the user's current business checkbook so of course it comes with a check register. The included register being digital will automatically update after a check is written keeping a more accurate record of your expenses. In its earliest incarnation the user will have to update the register manually when money is deposited/added into a bank account but later updates may be able to receive that information directly from the bank. When a user issues a check they will receive a notification alerting them to the remaining account balances which can help avoid overdraft of their accounts and eliminate overdraft fees from the banks. Since the program creates hard copies of checks the user will have to keep a supply of legal check stock. Since people are often forgetful they may run out of blank checks before they reorder. However, with our application you will be notified when you are low on your blank checks and you will be prompted to reorder every time you use the application until you order. Just by clicking “Order Button” that appears on the screen and confirming your order, your order is completed and error free. If you were to order your checks over the phone or online, it will take at least 10 minutes and you may make a mistake and your checks will not be usable. The application will always keep track of your check usage so you will always be notified to reorder when needed.

Users can choose to have multiple bank accounts and assign each to a different department. When checks printed to any specific department, it will have the designated bank information. Users can also elect to have one bank account and use it at multiple locations with multiple devices. These features are helpful if the user owns more than one business or uses different expense accounts for different purposes. Since all the devices are connected to one server check numbers always match and balances will always reconcile. Even though, there are multiple accounts and multiple users it still works as one.

This application is also equipped with a time clock and payroll software. Time clock can be used by the user's employees to clock in and out. Then pending a quick review by the user or person in charge of company's payroll the application will use the imputed pay amounts for each employee and put them through preset tax filters that are dependent on locality and process the payroll. Main user (employer) can determine when and how to deliver their employees checks, whether checks are hand delivered by a person on pay day or the device is programed to print employee paychecks from the device when employees punch in/out (employee verification required before checks printed). Majority of companies and employers use payroll services right now and pay a high service fee. With our application they can do all these tasks themselves with only a few inputs and avoid high payroll costs. The user can put limitations on the time clock by setting to certain features. They can use biometric scans, NFC chips or pin numbers to let the employees sign in. For users who have traveling employees the can use a GPS lock to be assured that the employee that clocked in is within allowed areas. After the time clock function has processed the data and the user has confirmed the accuracy then the application will prepare the paycheck. Once the pay checks are prepared and the employee signs out of their following shift they will receive a prompt asking them if they are ready to receive their check, if the employee taps the accept button the check will be printed and the employee will be able to take it.

In summary our product allows users to focus on other things while it does the work. They can share data with business partners and accountants or allow managers and supervisors to take up some of the responsibilities that can take up often too much of their day. This allows them to focus on the business without being as worried about the finances so that they might accomplish more in a day. Without the need to constantly worry about their expenses they will be more relaxed and have more time for their families.

While our mission for this project is to help make running a business easier overall, this does not in any way limit the use of our product to that market. An individual could utilize this application to manage their personal finances if they wish. That being said that is advisable only if they feel they need a digital accountant. This application is designed to help lower costs, simplify check writing, add more efficiency; more security features and gives everyone a neater and more organized checkbook.

### DRAWINGS/DIAGRAMS

FIG. 1. This diagram shows the boot processes for a returning user. It displays the program's security lock-out system if somebody without clearance were to attempt to gain access. After the security check it displays how the primary and non-primary users are separated.

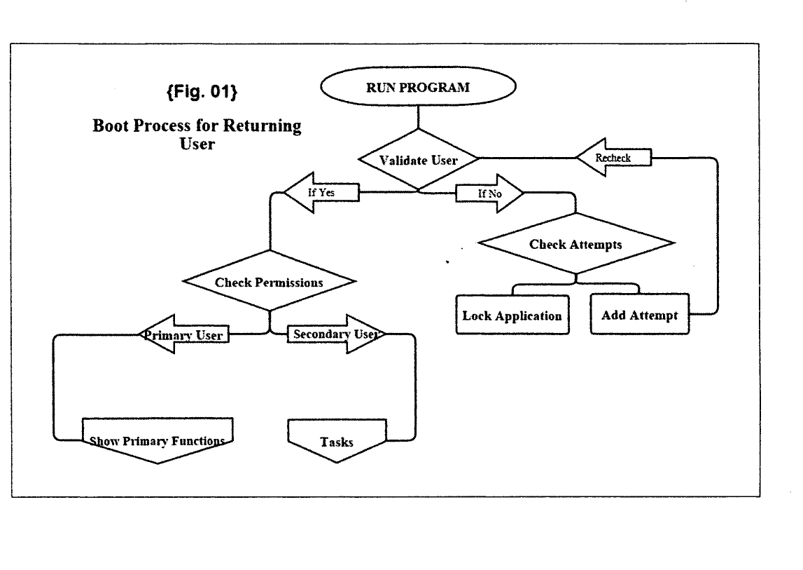

FIG. 2. This figure displays the data flow and accessibility given to the primary user aka the business owner. It shows how the can manage and view important finance data without any restriction. From their menus they may add or remove users, view expense reports or check scheduling for example.

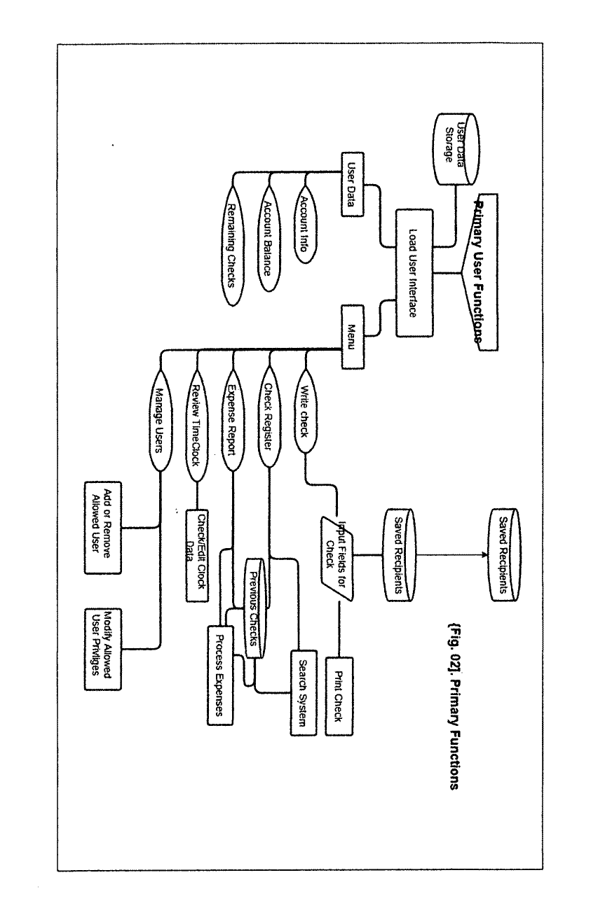

FIG. 3. This figure displays the different types of allowed users. It also show the difference in access that is granted to each level with more important people gaining more access but still limiting what they can do or see.

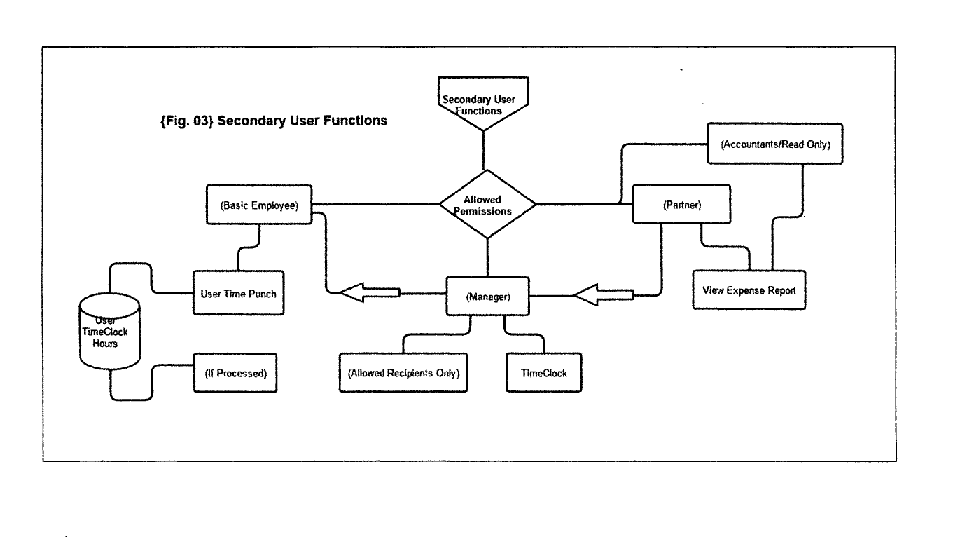

FIG. 4. This diagram shows the communication of the different devices that are useable by the users and the server. Showing the security and how a business owner might send a check to the store or how a manager might request that the owner do so.

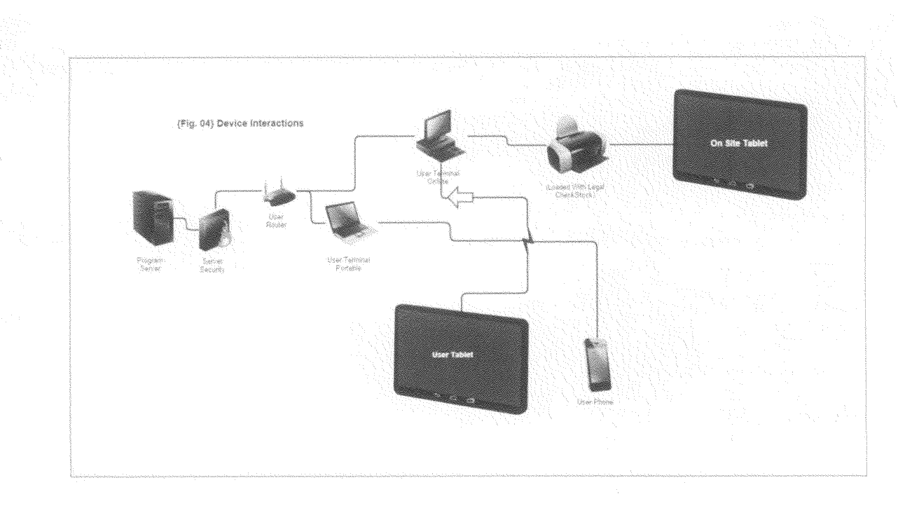

1. An application or computer program used to assist in the process of business management.

2. A function of claim 1 which comprises of a server used to back up and relay data and commands in order to manage a business's finances.

3. A function of claim 1 that creates employee work schedules and automatically alert the employees while they are off site.

4. A function of claim 1 used to calculate total hours worked by employees and process wages without the need of a third party.

5. A function of claim 1 that utilizes a biometric security program used to deny unauthorized users.

6. A function of claim 1 which is used to print business and wage checks from a remote location.

7. A time clock function of claim 1 that alerts employees when their check has been processed and allows them to print it at the end of their shift or after a security check has been satisfied.

8. A secondary security function of claim 1 using a pin, passphrase or a NFC chip in the case biometrics are not usable.

9. A function of claim 1 which allows business owners to share information with a business partner and/ or an accountant in real time without any extra work.

10. In one embodiment of claim 1 a program used to reduce the amount of monotonous tasks that are an everyday part of owning and managing a business.

11. A function of claim 1 used to produce advanced graphs and expense reports.

12. claim 1 in its preferred embodiment is a software incorporating a digital checkbook, a time clock and payroll processing.

13. A function of claim 1 which notifies the business owner or manager to order more when check stock is low.

14. In one embodiment of claim 1 a multi-tier user interface that allows different levels of access.

15. A function of claim 1 used to automatically print employee wage checks.

16. A facility of claim 1 that provides a data back-up and recovery function in case the business owner loses a device or files.

17. A supplementary function of claim 1 that notifies the user of their account balances.

18. A supplementary function of claim 1 that notifies the business owner when a check has been printed.

19. A function of claim 1 that syncs the book balance with the business owner's bank account.

20. A function of claim 1 that allows the business owner to write a check from different bank accounts.
